(19) United States
(12) Patent Application Publication
(10) Pub. No.: US 2012/0096338 A1
(43) Pub. Date: Apr. 19, 2012

(54) HYPERLINK TO COMPUTER GENERATED CONTENT

(76) Inventor: Baruch Bouzaglo, Paris (FR)

(21) Appl. No.: 13/262,920

(22) PCT Filed: Apr. 2, 2010
(86) PCT No.: PCT/IB10/51450

§ 371 Date: Dec. 18, 2011

Related U.S. Application Data
(60) Provisional application No. 61/166,757, filed on Apr. 5, 2009.

(51) Int. Cl. G06F 17/00

(52) U.S. Cl. 715/205

(57) ABSTRACT

A system and a method for linking a graphical element on a first web-page with a computer generated content presented in a second web-page, the method comprising the steps of retrieving a computer generated content to said second web-page, retrieving from said second web-page content-generation parameters for regenerating said content at said second web-page, said parameters not being web-address parameters, storing said parameters at said first web-page, and associating said parameters with said graphical element.

### FIELD AND BACKGROUND OF THE INVENTION

The present invention relates to information servers, and, more particularly but not exclusively, to hyperlinking from within a web-page to computer generated content.

Hyperlinks from an information item such as a web-page presented over the World-Wide-Web (WWW) to another information item such as another web-page presented over the WWW is well known in the art. Currently, a WWW hyperlink is based on the Uniform Resource locator (URL) of the target web-page, otherwise known as web address. Modern web-pages contain user-interactive content. This type of content is generated by the web server “on-the-fly”, typically in response to user indications. Such user indications can input data, zoom-in, zoom-out, pan, etc. An example of such interactive content is map search in which the user may enter a name of a target geographical location, then pan, and zoom to arrive at the most appropriate view of the map. When displaying a three-dimensional model the user may add view orientation, level of details, etc. A hyperlink as known in the art can transfer the user from the original web-page to the geographical information server (GIS) but not to the preferred view of the target location.

There is thus a widely recognized need for, and it would be highly advantageous to have, a hyperlinking method and system devoid of the above limitations.

### SUMMARY OF THE INVENTION

According to one aspect of the present invention there is provided a method for linking a graphical element on a first web-page with a computer generated content presented in a second web-page. The method includes the steps of:
retrieving a computer generated content to the second wen-page;
retrieving from the second web-page content-generation parameters for regenerating the content at the second web-page, the parameters not being web-address parameters;
storing the parameters at the first web-page; and
associating the parameters with the graphical element.

According to another aspect of the present invention there is provided a method for linking a graphical element on a first web-page with a computer generated content presented in a second web-page wherein the computer generated content includes a map.

According to still another aspect of the present invention there is provided a method for linking a graphical element on a first web-page with a computer generated content presented in a second web-page wherein the content-generation parameters comprise at least one of view orientation, view magnification; and zoom.

According to still another aspect of the present invention there is provided a method for linking a graphical element on a first web-page with a computer generated content presented in a second web-page additionally including the step of displaying collateral information on the first web-page, the collateral information including a link to a third web-page, wherein the third web-page is associated with at least one of: the content of second web-page, and the content-generation parameters.

Further according to another aspect of the present invention there is provided a method for linking a graphical element on a first web-page with a computer generated content presented in a second web-page wherein the content-generating link additionally includes a third information server operative to provide the collateral information responsive to the content-generating parameters.

Yet further according to another aspect of the present invention there is provided a system for linking a graphical element on a first web-page with a computer generated content presented in a second web-page. The system includes:
a first information server operative to generate a first displayable content responsive to content-generating parameters provided by a user;
a second information server containing a second displayable content including a content-generating link to the first information server; and
a network display device communicating over a communication network with the first information server, and operative to receive the second displayable content from the second information server and to enable a user to invoke the content-generating link to the first information server and to transfer the content-generating parameters to the information server and to receive the first displayable content;
wherein the content-generating link includes the content-generating parameters for generating the first displayable content by the first information server.

Still further according to another aspect of the present invention there is provided a system for linking a graphical element on a first web-page with a computer generated content presented in a second web-page additionally including a third information server communicating with the second information server, wherein the content-generating link additionally includes link to the third information server and wherein the third information server is operative to provide collateral information responsive to the content-generating parameters.

Even further according to another aspect of the present invention there is provided a system for linking a graphical element on a first web-page with a computer generated content presented in a second web-page wherein the collateral information includes a link to a web-page associated with at least one of: the content of second web-page, and the content-generation parameters.

Additionally according to another aspect of the present invention there is provided a system for linking a graphical element on a first web-page with a computer generated content presented in a second web-page wherein the third information server additionally operative to retrieve the content-generating parameters from the first information server on behalf of the second information server.

Also according to another aspect of the present invention there is provided a system for linking a graphical element on a first web-page with a computer generated content presented in a second web-page wherein the third information server additionally operative to retrieve the first displayable content responsive to the content-generating parameters from the first information server on behalf of the second information server.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases the order of process steps may varied without changing the purpose or effect of the methods described.

Implementation of the method and system of the present invention involves performing or completing certain selected tasks or steps manually, automatically, or any combination thereof. Moreover, according to actual instrumentation and equipment of various embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the various embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified illustration of a virtual hyperlinking system connecting a visual element in a first web-page to a second web-page that is generated on-demand.

### DETAILED DESCRIPTION OF THE INVENTION

The principles and operation of a system and a method for virtual hyperlinking according to the present invention may be better understood with reference to the drawings and accompanying description.

In this document, the term to “virtual hyperlinking” or “virtual hyperlink” refers to a hyperlink from a first web-page to a second web-page wherein at least a part of the content of the second web-page is “computer generated content”. The term “computer generated content” refers to content generated for the associated web-page “on-the-fly”, typically in response to input data provided by a user. In the virtual hyperlinking system and method described herein, the input data to generate the content within the second web-page is provided by the virtual hyperlink embedded within the first web-page.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text has the same use and description as in the previous drawings where it was described.

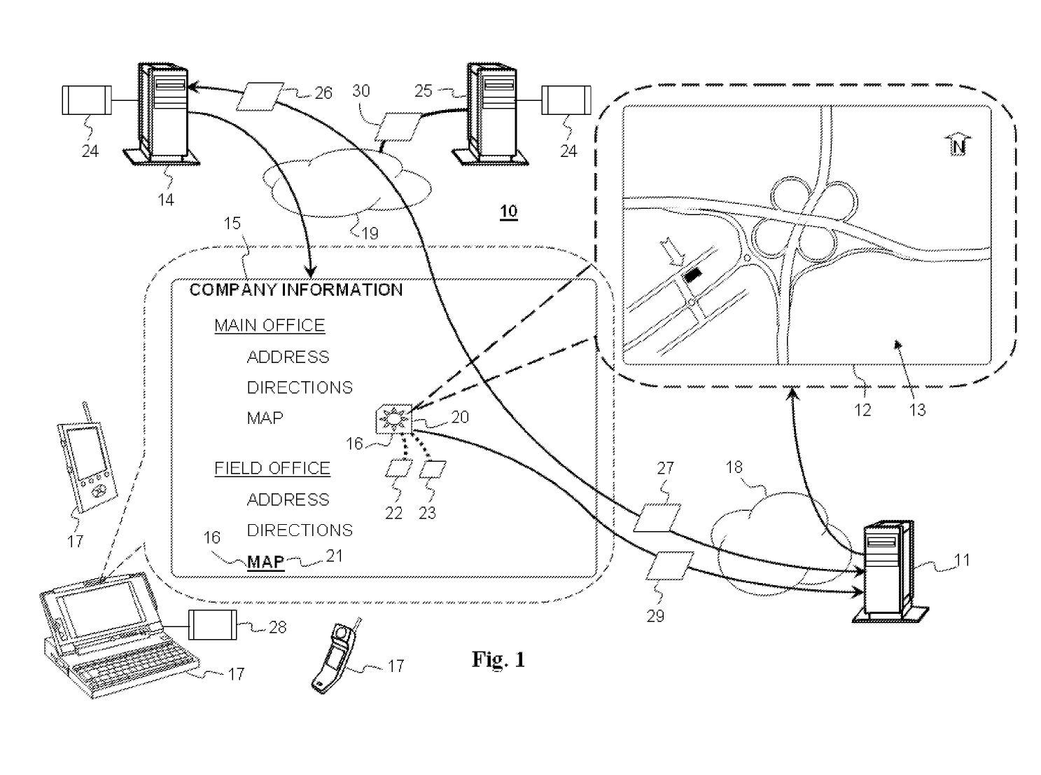

Reference is now made to FIG. 1, which is a simplified illustration of a virtual hyperlinking system 10 connecting a visual element in a first web-page to a second web-page that is generated on-demand. according to an embodiment of the present invention.

As seen in FIG. 1 the virtual hyperlinking system 10 preferably contains the following elements:
a first information server 11 containing a first web-page 12 containing computer-generated content 13;
a second information server 14 containing a second web-page 15 containing one or more virtual hyperlinks 16 to the computer-generated content 13;
a network display device 17, such as a desktop computer, a laptop computer, a PDA, a cellular telephone, etc., communicating via a communication network 18 with the first information server 11 and via a communication network 19 with the second information server 14;

It is appreciated that the communication networks 18 and 19 can be the same network. It is also appreciated that the communication networks 18 and/or 19 can be any type of communication network such as a wired communication network and/or a wireless communication network, such as WAN, MAN, LAN or PAN communication networks, such as telephone network, cellular network, IP network, WiMAX, WiFi or Bluetooth networks. Preferably, the communication networks 18 and/or 19 use the Internet, and particularly the World-Wide-Web (WWW).

It is appreciated that the first web-page 12 and the second web-page 15 contain displayable content and that the network display device 17 can display the displayable content. Typically, the network display device 17 use a regular Internet browser and the first web-page 12 and the second web-page 15 contains content displayable by an Internet browser.

The first information server 11 typically generates the computer-generated content 13 on-the-fly in response to data input and instructions from a user. The computer-generated content 13 is therefore typically not present on the first information server 11 as a fixed web-page, but is presented on-demand, in response to the user's request, and/or query, and/or input and/or instructions. For example, a map is presented by the first information server 11 after a user has entered the required location, typically by entering text such as the name of a city, the name of a street, the name of a geographical location or entity such as a mountain or a lake, etc. When the map is presented the user can zoom in or zoom out and/or pan the image to arrive at the most useful view of the area.

The user may also request the first information server 11 to add or remove details such as hotels, petrol stations, restaurants, etc. This type of content is typically available at the first information server 11 but presented to each user upon user's request.

If the computer-generated content 13 contains a three-dimensional view of a three-dimensional model the user can further manipulate the computer-generated content 13 according, for example to the preferred viewing orientation.

In other types of computer-generated content 13 the user can add elements to the image, such as visual marks, annotations, etc. The first information server 11 can save the added elements and display them to the user when the user requests the appropriate computer-generated content 13. However, these elements are not available to other users.

As seen in FIG. 1, the second information server 14 preferably contains the second web-page 15 that is communicated to, and displayed by, the network display device 17. The second web-page 15 preferably contains one or more virtual hyperlinks 16. The virtual hyperlinks 16 can take the form of an icon, such as the virtual hyperlink 16 designated by numeral 20, or as a text, preferably designated by a different color, underlined fonts, different font type, highlighting, etc., such as the virtual hyperlink 16 designated by numeral 21.

The virtual hyperlink 16 preferably contains web address 22 of the first web-page 12, or, alternatively, web address of the first information server 11, and context information 23 required to cause the first information server 11 to generate a specific computer-generated content 13.

Thus, when a user accesses the second web-page 15 and invokes a virtual hyperlink 16 the network display device 17 preferably instructs the first information server 11 to generate a specific computer-generated content 13 as designated by a programmer of the second web-page 15.

To enable the programmer of the second web-page 15 to create the virtual hyperlink 16 and to embed in it the context information 23, the second information server 14 preferably contains a hyperlinking program 24. Alternatively, the hyperlinking program 24 resides on a third information server 25, also connected to the communication network 19.

When creating the virtual hyperlink 16, the programmer accesses the first information server 11 and invokes a recording process of the hyperlinking program 24. The programmer accesses the first web-page 12 and performs all the user activities required to generate the computer-generated content 13. The recording process records these user activities. Preferably, the recorded activities include actions such as text entries, check-box selections, radio-button selections, zoom, pan and similar image manipulations, etc. The recorded activities are then packed by the hyperlinking program 24 as the context information 23 and embedded in the virtual hyperlink 16.

Alternatively, the programmer accesses the first web-page 12 and performs all the user activities required to generate the computer-generated content 13. Then the programmer invokes the hyperlinking program 24 that sends a link request 26 to the first web-page 12. In response to the link request 26, the first web-page 12 sends to the hyperlinking program 24 all the information (element 27 of FIG. 1) required to generate the computer-generated content 13 as specified by the user. The hyperlinking program 24 packs this information in the form of the context information 23 and embeds it in the virtual hyperlink 16.

The network display device 17 preferably includes a virtual hyperlinking routine 28, typically implemented as an add-on (plug-in) module for the web-browser software. When the user invokes the virtual hyperlink 16 the virtual hyperlinking routine 28 accesses the first information server 11 (or the first web-page 12) and sends it the context information 23 to generate the required computer-generated content 13 (element 29 of FIG. 1).

Thereafter, the first information server 11 generates the computer-generated content 13 according to the context information 23 and the computer-generated content 13 is communicated to the network display device 17, which then preferably displays the computer-generated content 13 to the user.

Alternatively, the context information 23 is communicated from the network display device 17 to the first information server 11 via the third information server 25, and the responsive computer-generated content 13 is communicated from the first information server 11 to the network display device 17 via the third information server 25. The third information server 25 additionally maintains a database of collateral information, such as advertising, that is indexed according to parameters that are common in the context information 23. The third information server 25 uses the communicated context information 23 to search and retrieve appropriate collateral information 30 and add it to the computer-generated content 13 communicated back to the network display device 17.

It is expected that during the life of this patent many relevant communication technologies will be developed, and the scope of the terms herein, such as link, hyperlink, map server, geographical information system and three-dimensional model display, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for linking a graphical element on a first web-page with a computer generated content presented in a second web-page, the method comprising the steps of:
retrieving a computer generated content to said second web-page;
retrieving from said second web-page content-generation parameters for regenerating said content at said second web-page, said parameters not being web-address parameters;
storing said parameters at said first web-page; and
associating said parameters with said graphical element.

2. The method of claim 1 wherein said computer generated content comprises a map.

3. The method of claim 1 wherein said content-generation parameters comprise at least one of:
view orientation;
view magnification; and
zoom.

4. The method of claim 1 additionally comprising the step of:
displaying collateral information on said first web-page, said collateral information comprising a link to a third web-page, wherein said third web-page is associated with at least one of:
said content of second web-page; and
said content-generation parameters.

5. The method of claim 4 wherein said content-generating link additionally comprises a third information server operative to provide said collateral information responsive to said content-generating parameters.

6. A system for linking a graphical element on a first web-page with a computer generated content presented in a second web-page, the system comprising:
a first information server operative to generate a first displayable content responsive to content-generating parameters provided by a user;
a second information server containing a second displayable content comprising a content-generating link to said first information server; and
a network display device communicating over a communication network with said first information server, and operative to receive said second displayable content from said second information server and to enable a user to invoke said content-generating link to said first information server and to transfer said content-generating parameters to said information server and to receive said first displayable content;
wherein said content-generating link comprises said content-generating parameters for generating said first displayable content by said first information server.

7. A system according to claim 6 additionally comprising a third information server communicating with said second information server, wherein said content-generating link additionally comprises link to said third information server and wherein said third information server is operative to provide collateral information responsive to said content-generating parameters.

8. A system according to claim 7 wherein said collateral information comprises a link to a web-page associated with at least one of:
said content of second web-page; and
said content-generation parameters.

9. A system according to claim 7 wherein said third information server additionally operative to retrieve said content-generating parameters from said first information server on behalf of said second information server.

10. A system according to claim 7 wherein said third information server additionally operative to retrieve said first displayable content responsive to said content-generating parameters from said first information server on behalf of said second information server.
